(19) United States
(12) Patent Application Publication
(10) Pub. No.: US 2017/0337148 A1
(43) Pub. Date: Nov. 23, 2017

(54) Method for Synchronizing Touch Control Functions for Smartphone and Tablet Computer

(71) Applicant: Johnny Chen, Taipei City (TW)

(72) Inventor: Johnny Chen, Taipei City (TW)

(73) Assignee: I/O INTERCONNECT, LTD., Santa Ana, CA (US)

(21) Appl. No.: 15/161,285

(22) Filed: May 23, 2016

(51) Int. Cl. G06F 13/38; G06F 13/42

(52) U.S. Cl. CPC G06F 13/385; G06F 13/4282

(57) ABSTRACT

The invention provides a method for synchronizing touch control functions when a smartphone based on a first OS is connected to a tablet computer based on a second OS. The method includes the steps: a) operationally connecting the tablet computer to the smartphone to project a screen picture of the smartphone onto the tablet computer; b) pressing an active window of the tablet computer; c) intercepting a touch event of the tablet computer; d) converting the touch event into a format compatible with the first OS of the smartphone; e) sending the touch event to the smartphone; f) executing the touch event by the smartphone to generate a resultant screen picture; and g) showing the resultant screen picture on the tablet computer.

### BACKGROUND OF THE INVENTION

### 1. Technical Field

The invention relates to handheld touchscreen computers such as smartphones and tablet computers, particularly to operational synchronization between a tablet computer and a smartphone.

### 2. Related Art

Handheld touchscreen computers, such as smartphones and tablets, have become essential for most people. Some users of smartphones have the need to connect their smartphone to a tablet computer that serves as a larger display. In some cases, the smartphone and the tablet computer connected thereto are based on two different and incompatible operating systems. For example, the smartphone and tablet computer are based on Android and Apple iOS, respectively or in reverse order. When a smartphone is connected to a tablet computer, and a screen picture of the smartphone is projected on the tablet computer, users are still able to utilize touch control functions of the tablet computer as though they were directly operating a smartphone.

However, an operating system used in a tablet computer, such as Apple iOS, has natively defined functions with respect to various touch operations such as swiping, tapping, sliding to scroll, dragging to rearrange, and pinching or stretching to zoom. For example, a long press gesture (touch and hold) may generate different operational results for different OSes.

Such a difference in response to two seemingly identical operations as applied to two different operating systems almost always confuses and annoys users of smartphones because they would still feel that they are operating a smartphone. However, as yet there is no solution on the market to effectively diffuse this confusion.

### SUMMARY OF THE INVENTION

An object of the invention is to provide a method for synchronizing touch control functions for a smartphone and a tablet computer, which can directly convert the native touch control functions of a tablet computer based on a first OS into corresponding functions which are the same as a smartphone with a second OS. In other words, operating a tablet computer which is connected to a smartphone that projects a screen picture thereof onto the tablet computer is the same as operating a smartphone.

To accomplish the above object, the method of the invention includes the steps of: a) operationally connecting the tablet computer to the smartphone to project a screen picture of the smartphone onto the tablet computer; b) pressing an active window of the tablet computer; c) intercepting a touch event of the tablet computer; d) converting the touch event into a format compatible with the first OS of the smartphone; e) sending the touch event to the smartphone; f) executing the touch event by the smartphone to generate a resultant screen picture; and g) showing the resultant screen picture on the tablet computer.

### BRIEF DESCRIPTION OF THE DRAWINGS

FIG. 1 is a schematic view of hardware arrangement of the invention; and

FIG. 2 is a flowchart of the method of the invention.

### DETAILED DESCRIPTION OF THE INVENTION

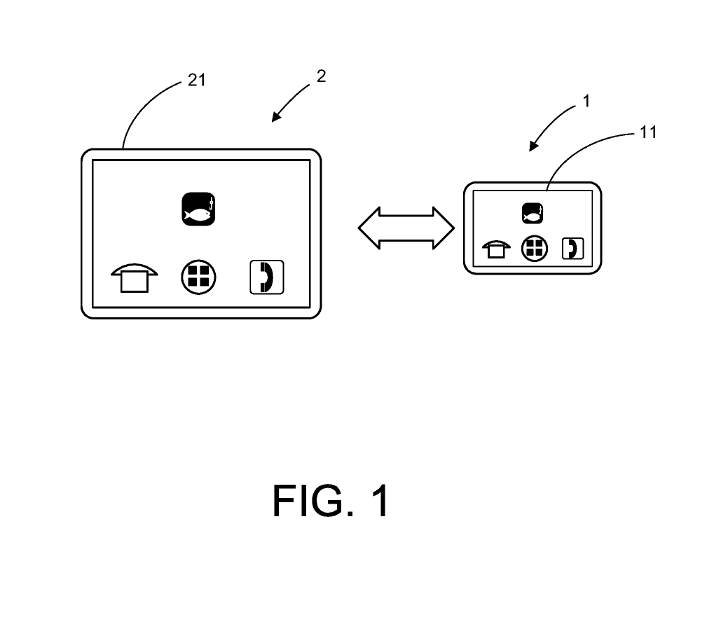

Please refer to FIG. 1. The invention provides a method for synchronizing touch control functions for a smartphone 1 and a tablet computer 2. The smartphone 1 and the tablet computer 2 are based on a first operating system (OS) and a second operating system (OS), respectively. The first OS is different from and incompatible with the second OS. For example, the first OS may be Android or Apple iOS, and the second OS may be Android, Apple iOS or Windows. Of course, the smartphone 1 and the tablet computer 2 must be provided with a first touchscreen 11 and a second touchscreen 21, respectively.

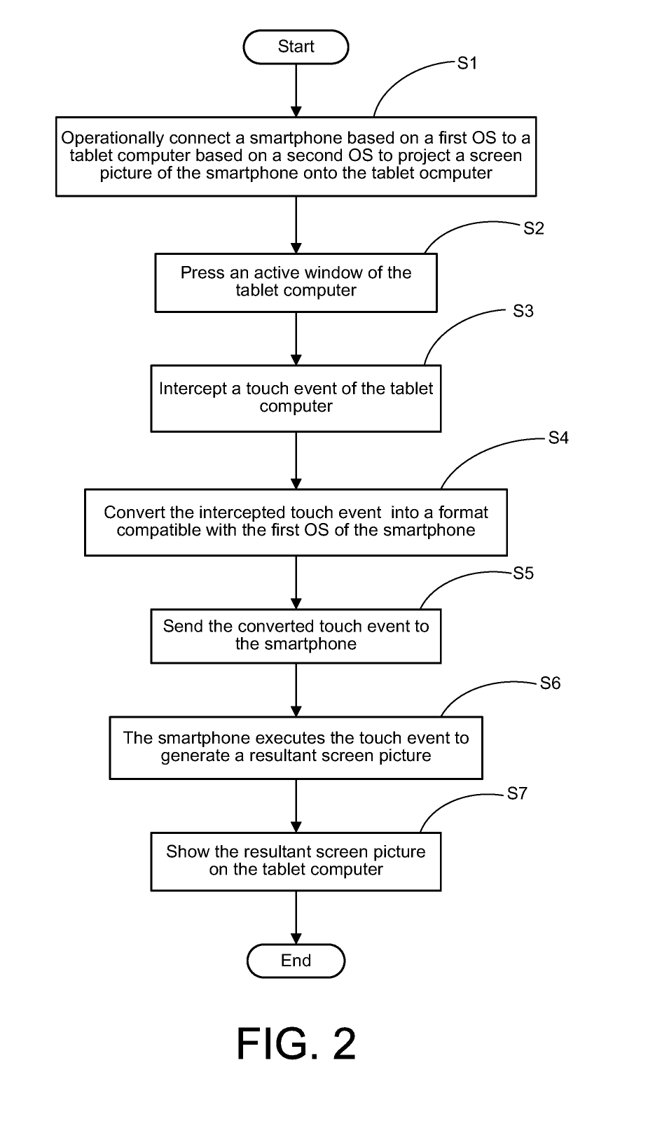

Please refer to FIG. 2, which shows a flowchart of the method of the invention. In step S1, the tablet computer 2 is operationally connected to the smartphone 1 to project a screen picture of the first touchscreen 11 of the smartphone 1 on the second touchscreen 21 of the tablet computer 2. In other words, the screen picture of the smartphone 1 will be the same as that of the tablet computer 2.

The connection between the smartphone 1 and the tablet computer 2 may be wired or wireless. The wired connection may be a USB (universal serial bus) cable or an HDMI (high definition multimedia interface) cable, and the wireless connection may utilize the BLUETOOTH or Wi-Fi communication protocol. Additionally, the tablet computer 2 must be installed with a proprietary software application.

In step S2, a user presses an active window of the second touchscreen 21 of the tablet computer 2. The active window is the projected screen picture of the smartphone 1. Also, the active window may be a full screen or non-full screen. In step S3, the software application is activated to intercept a touch event of the tablet computer 2, in which the touch event is generated by the pressing operation of the step S2. In step S4, the software application converts the touch event incepted in step S3 into a format compatible with the first OS of the smartphone 1.

In step S5, the software application sends the touch event converted in step S4 to the smartphone 1. In step S6, the smartphone 1 executes the touch event to generate a resultant screen picture. That is, the pressing operation of step S2 on the tablet computer 2 has been applied to the smartphone 1. Finally, in step S7, the resultant screen picture of the smartphone 1 is shown on the tablet computer 2 by means of projection of step S1. As a result, users may operate the second touchscreen 21 of the tablet computer 2 by the same manner as operating the first touchscreen 11 of the smartphone 1.

The invention offers a great convenience to users by assimilating non-identical operations between a smartphone and a tablet computer when they have been operationally connected.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for synchronizing a touch control function between a smartphone based on a first operating system (OS) and a tablet computer based on a second operating system (OS), comprising following steps in the order named:
a) operationally connecting the tablet computer to the smartphone to project a screen picture of the smartphone onto the tablet computer;
b) pressing an active window of projected screen on the tablet computer;
c) intercepting a touch event of the tablet computer;
d) converting the touch event incepted in step c) into a format compatible with the first OS of the smartphone;
e) sending the touch event converted in step d) to the smartphone;
f) executing the touch event by the smartphone to generate a resultant screen picture; and
g) showing the resultant screen picture on the tablet computer.

2. The method of claim 1, wherein the first OS is Android or iOS.

3. The method of claim 1, wherein the second OS is Apple iOS, Windows or Android.

4. The method of claim 1, wherein a connection between the smartphone and the tablet computer is a wired link.

5. The method of claim 4, wherein the wired link is a USB (universal serial bus) cable or an HDMI (high definition multimedia interface) cable.

6. The method of claim 1, wherein a connection between the handheld computer and the desktop computer is a wireless link.

7. The method of claim 6, wherein the wireless connection is a BLUETOOTH or Wi-Fi communication protocol.

8. The method of claim 6, wherein the active window is a full screen one.

9. The method of claim 6, wherein the active window is a non-full screen one.
